(19) United States
(12) Patent Application Publication
(10) Pub. No.: US 2007/0135069 A1
(43) Pub. Date: Jun. 14, 2007

(54) APPARATUS AND METHOD OF MIMO DETECTION

(75) Inventors: Josep Vicent Soler Garrido, Bristol (GB); Robert Jan Piechocki, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/531,852

(22) Filed: Sep. 14, 2006

(30) Foreign Application Priority Data
Sep. 30, 2005 (GB) 0519991.4

(51) Int. Cl. H04B 1/16

(52) U.S. Cl. 455/214

(57) ABSTRACT

An analogue multiple input, multiple output (MIMO) detector, comprises an analogue calculator circuit operable to obtain the binary elements of a joint posterior distribution of the probabilities for a transmitted symbol, given a received signal. These probabilities are passed as currents to a marginaliser circuit for each channel, which selects the most probable value for the respective channel's bit.

The invention relates to an apparatus and method of detection, and in particular to an apparatus and method of detection for MIMO receivers using analogue electronics.

In modern high-speed wireless communications networks, multipath signal propagation is an increasingly significant problem. In traditional wireless communication, a transmit antenna emits an electromagnetic (EM) signal to a receive antenna over an intervening space. However, any obstructions to the signal within that space scatter the EM signal, resulting in copies of the signal reaching the receive antenna at different times and at different intensities via different paths; an effect known as channel spread. In a digital signal, channel spread results in an overlap between successive received bits, and this reduces the confidence in any given bit value received.

In order to increase bit transmission rates, it is necessary to devise shorter bit representations. Consequently, the relative size of channel spread increases with decreasing bit representation, and so the overlap caused by channel spread correspondingly increases. This makes disambiguation of the received bit stream more difficult. Therefore in high-speed wireless networks, there is a need to mitigate the effect of channel spread.

One approach is multiple input, multiple output (MIMO) communication, wherein multiple transmitter and receiver aerials are used. MIMO systems improve communications robustness by providing multiple, path-independent copies of the transmitted data. This is typically achieved by use of space-time coding techniques, for example Alamouti orthogonal space-time block coding (see S. M. Alamouti, A Simple Transmit Diversity Technique for Wireless Communications, IEEE Journal on Select Areas in Communications, vol. 16, no. 8, October 1998). The result is a set of received signals in which path induced interference differs for each copy of the data, simplifying disambiguation of the common and disparate signal components.

However, MIMO decoding is non-trivial. Typical detectors use digital signal processing (DSP) methods to decode a MIMO signal; this may involve multiple sampling of each candidate bit signal for each MIMO receiver, and calculating and aggregating bit value probabilities for each sample. These steps incur large computational costs relative to the actual bit rate. The computational costs in turn carry a corresponding power cost that is significant in portable MIMO devices, and can also cause a processor bottleneck that limits throughput in high data rate applications. This problem also occurs in other applications where a receive signal is equalised to estimate the source signal, such as surface reading in magnetic storage media.

Recently, an alternative method of MIMO detection has been proposed using analogue circuitry rather than digital signal processing (see Piechocki, R. J., Garrido, J., McNamara, D., and McGreen, J., ‘Analogue MIMO detector: The Concept and Initial Results’, IEEE First International Symposium on Wireless Communications Systems, Mauritius, 20-22^{nd} Sep. 2004).

Advantageously, analogue circuitry does not require quantisation of the incoming signal, i.e. mapping of analogue measurements to bit values, and can operate directly on the ‘soft’, probabilistic values observed by the receivers. Moreover, the circuitry can be constructed to operate in parallel upon the multiple receiver channels.

In consequence, equivalent detector processing can be performed several orders of magnitude more quickly than by a DSP equivalent, whilst requiring less power.

However, the analogue solution to MIMO detection proposed in Piechocki et. al. above is not optimal for a number of reasons. In particular, it makes use of a substantial number of independent transistor based circuitry arrangements for each signal operation that is required. Thus, the analogue circuits merely provide approximations of the equivalent theoretical and desired arrangements. There is no use of convenient analogue circuits to reach the desired functional result in more elegant and effective ways.

Further, the number of transistors required in Piechocki et al. is of exponential order of complexity with respect to the number of receiver channels.

Thus there is scope for an improved analogue detector that provides good performance whilst limiting the impact of an exponential ratio between transistors and channels.

In a first aspect of the present invention, a multiple input, multiple output (MIMO) detector comprises an analogue calculator operable to produce a binary representation of a joint posterior distribution of the probabilities for at least a first transmitted symbol, given a received MIMO signal.

In a preferred configuration of the above aspect, the detector comprises a marginaliser arranged in operation to receive currents representative of said joint posterior distributions, and operable to select the highest of such currents.

In a preferred configuration of the above aspect, the detector comprises a respective marginaliser for each transmitted bit stream of the MIMO signal, and each said marginaliser comprises a circuit operable to arrange probability distributions relating to a first respective bit value so as to compete together against distributions relating to a second respective bit value.

In a preferred configuration of the above aspect, the analogue calculator is configured to use voltages as log-likelihood inputs, or currents as probability inputs.

In a further aspect of the present invention, a receiver comprises an analogue MIMO decoder as defined above.

In an aspect of the present invention, a receiver comprising digital signal processing means is operably coupled to an analogue MIMO decoder as defined above.

In an aspect of the present invention, a method of MIMO signal reception comprises the step of using an analogue circuit to calculate the binary elements of a joint posterior distribution of the probabilities for a transmitted signal given a received signal.

In a preferred configuration of the above aspect, the method further comprises the steps of representing said binary distributions by current signals, and marginalising said binary distributions by selecting the distribution represented by the highest current.

In an aspect of the present invention, a data carrier comprises computer readable instructions that, when loaded into a computer, cause the computer to operate as a receiver operable to couple with an analogue MIMO decoder as claimed herein.

Embodiments of the present invention will now be described by way of example with reference to the accompanying drawings, in which:

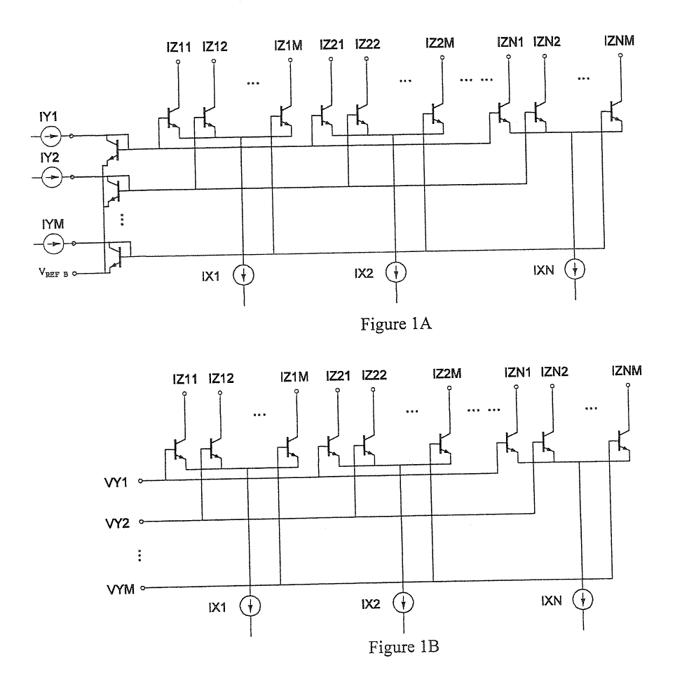

FIG. 1A shows a circuit operable to multiply a representation of probabilities input as currents, in accordance with an embodiment of the present invention.

FIG. 1B shows a circuit operable to multiply a representation of probabilities input as voltages, in accordance with an embodiment of the present invention.

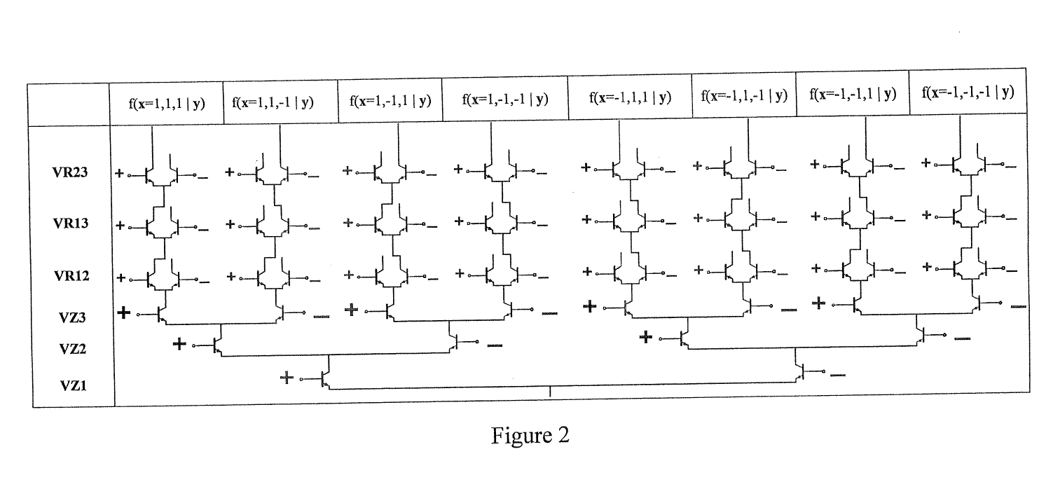

FIG. 2 tabulates the branching circuits used in an analogue decoding tree for NT=3 transmitters, in accordance with an embodiment of the present invention.

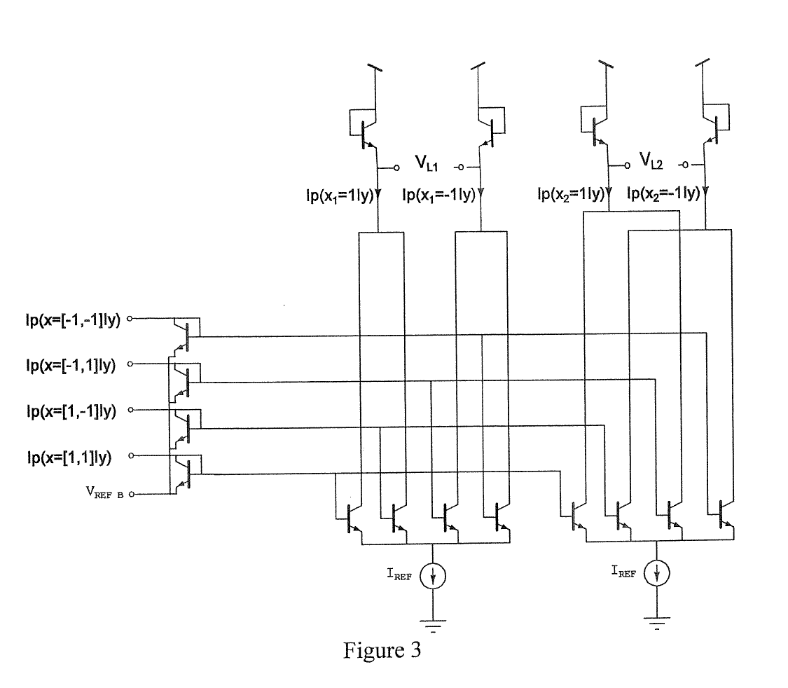

FIG. 3 shows a marginaliser circuit in accordance with an embodiment of the present invention.

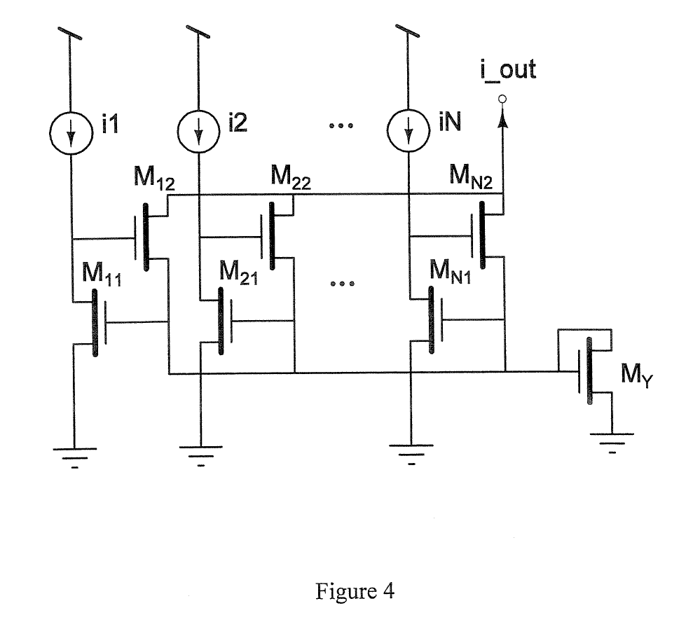

FIG. 4 shows a circuit operable to select the highest from amongst a plurality of input currents, in accordance with an embodiment of the present invention.

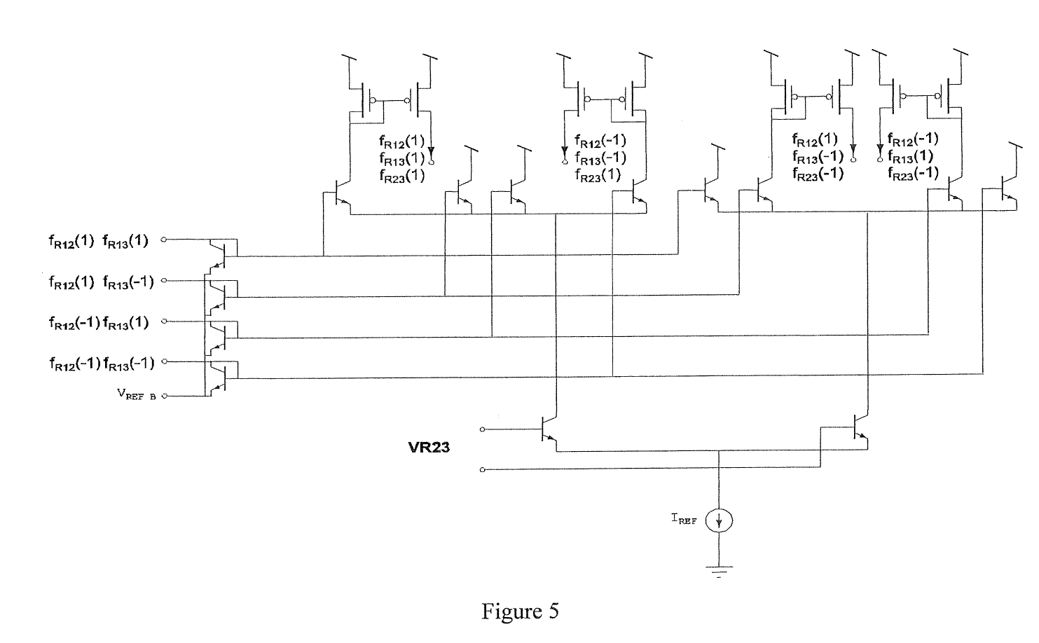

FIG. 5 shows a circuit forming part of a decoding tree in accordance with an embodiment of the present invention.

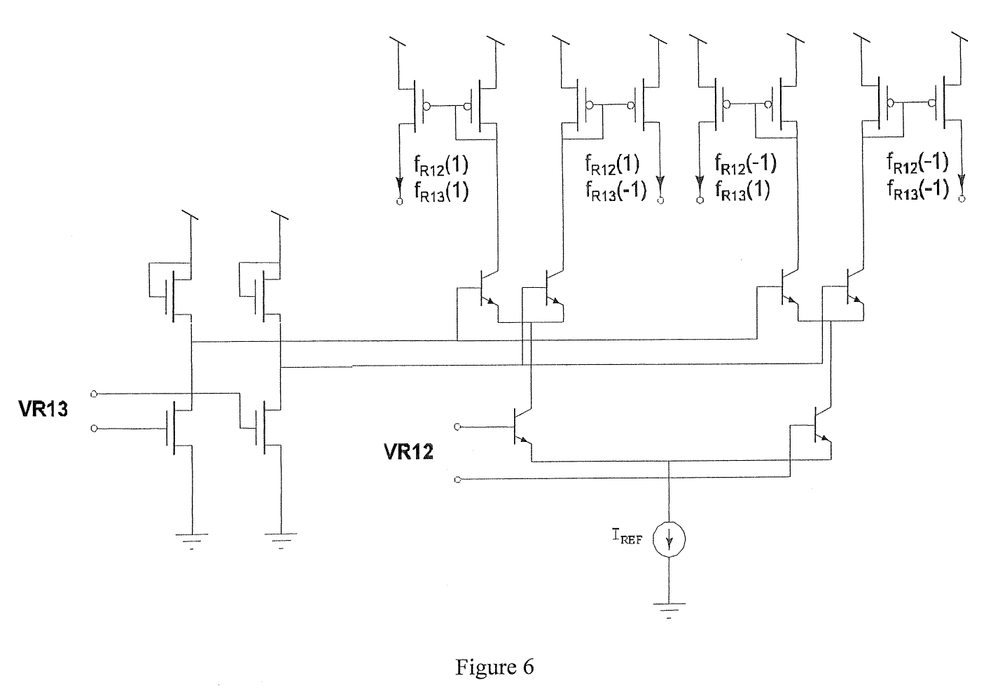

FIG. 6 shows a circuit forming part of a decoding tree in accordance with an embodiment of the present invention.

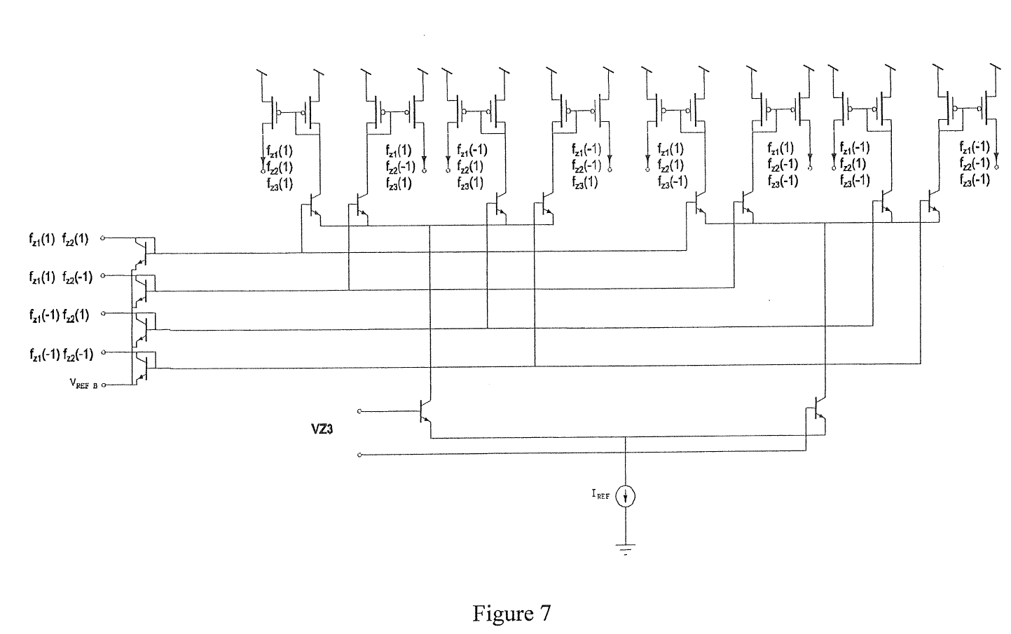

FIG. 7 shows a circuit forming part of a decoding tree in accordance with an embodiment of the present invention.

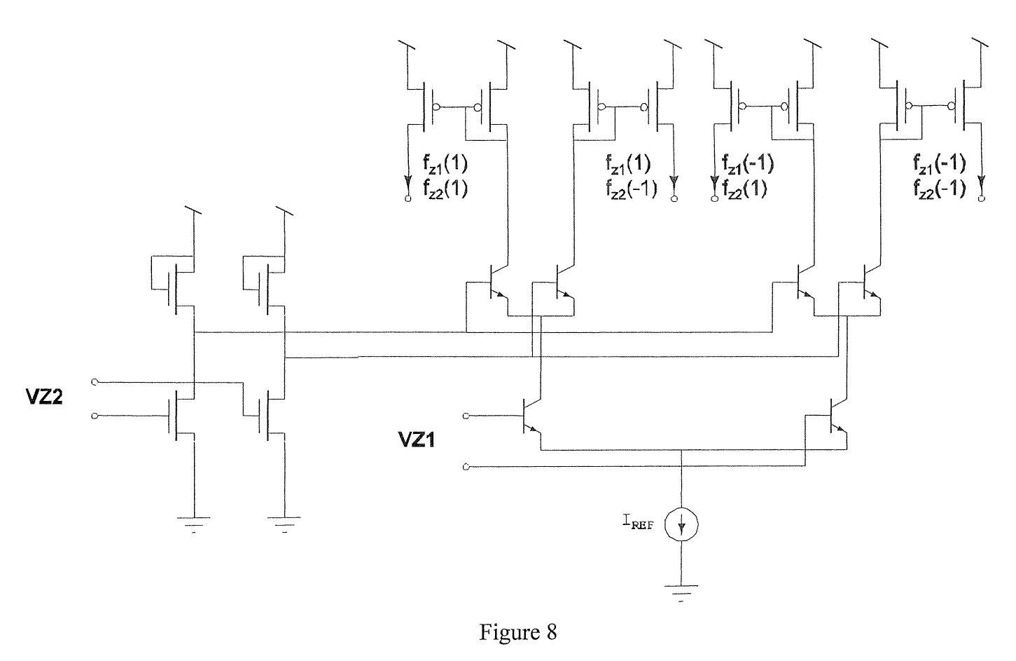

FIG. 8 shows a circuit forming part of a decoding tree in accordance with an embodiment of the present invention.

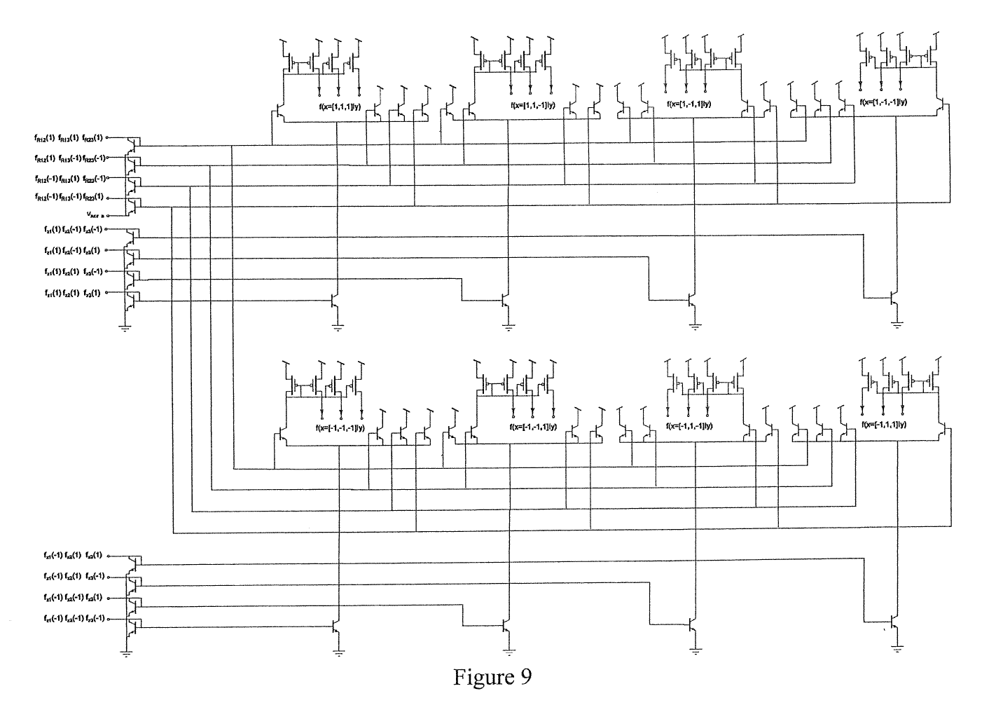

FIG. 9 shows a decoding tree circuit in accordance with an embodiment of the present invention.

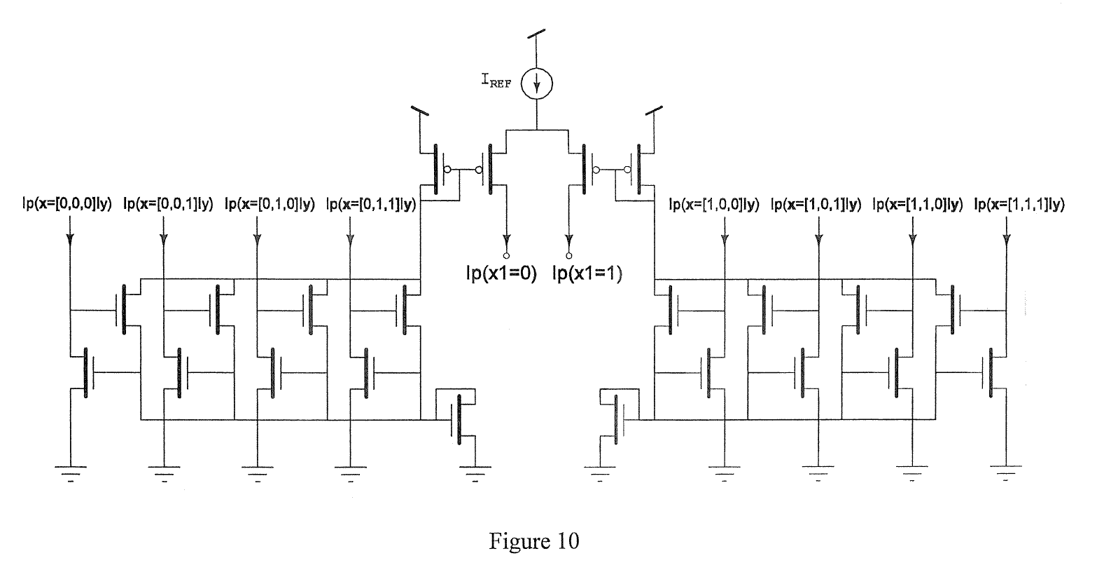

FIG. 10 shows a marginalisation circuit for a bit channel in accordance with an embodiment of the present invention.

An analogue MIMO detector in accordance with a specific embodiment of the invention is disclosed. In the following description, a number of specific details are presented in order to provide a thorough understanding of embodiments of the present invention. It will be apparent to a person skilled in the art, however, that these specific details need not be employed to practice the present invention.

The MIMO detector described herein attempts to simplify the process of obtaining a full probability distribution as proposed in Piechocki et. al. above, by expressing the desired distribution in terms of sums and products of the elements of simple binary distributions.

Circuits that can be used to perform these operations are known in the art. However, the described embodiment provides an arrangement which takes advantage of component efficiency in the detector such that only one transistor is needed per multiplication and none is required for summing. This efficient design mitigates the exponential relationship between circuit complexity and the number of receiver channels, extending the practical applicability of an analogue detector.

The approach taken is based upon the association of probabilities with electric currents, and the ability to process them in continuous time within a network of analogue transistors, routing and modifying the currents appropriately and exploiting rather than avoiding the non-linear characteristics of these devices to beneficial ends.

Thus, digital logic gates are supplanted by soft analogue gates that, with a reduced number of transistors, can perform operations with real values. Although these analogue units are individually less accurate than digital processors, a plurality of them in combination can offer good overall accuracy.

However, to efficiently implement such a network of soft analogue gates requires the formulation of a MIMO detection method in such a way that it is amenable to such analogue circuitry.

Accordingly, a derivation of maximum a posteriori multiple input, multiple output (MAP MIMO) detection suitable for efficient analogue implementation is presented below.

The present example is demonstrated using a binary phase shift keying (BPSK) MIMO system with N_{T} transmit antennas and N_{R} receive antennas. The signal model is given by
y=a·Hx+n
where
x—is a data vector, with xᵢε[−1,1];
a—is a normalisation constant a=1/\sqrt{N_{T}} so the total energy per symbol is 1;
y—is the received vector;
H—is the N_{R}×N_{T} MIMO channel, and;
n—is independently and identically distributed Gaussian noise; n˜N(0,σₙ²).

The objective is to detect the transmitted bits x, given y and assuming knowledge of H. Specifically, it is to determine the set of posterior probabilities p(xᵢ|y).

One way to achieve this is to calculate the joint posterior distribution over all the transmitted bits, and then marginalise out each variable. In this case it is necessary to calculate the terms

$$f ( x \vert y ) ∝ f ( y \vert x ) \cdot f ( x ) = {\prod }_{i = 1}^{NR} f ( {y}_{i} \text{\vert} x ) \cdot {\prod }_{j = 1}^{NT} {f}_{prior} ( {x}_{j} ) \\ where \\ f ( {y}_{i} \text{\vert} x ) = exp ( - \frac{1}{{σ}_{n}^{2}} {\vert {y}_{i} - a {\sum }_{j = 1}^{NT} {h}_{i , j} {x}_{j} \vert}^{2} ) \qquad ( 1 )$$

Equation (1) can be expanded and simplified in order to remove the terms common to all the elements of the posterior distribution:

$$\begin{matrix}f ( {y}_{i} \text{\vert} x ) = exp ( - \frac{1}{{σ}_{n}^{2}} ( {y}_{i}^{2} - 2 {ay}_{i} {\sum }_{j = 1}^{NT} {h}_{i , j} {x}_{j} + {a}^{2} {\sum }_{j = 1}^{NT} {( {h}_{i , j} {x}_{j} )}^{2} + \\ 2 {a}^{2} {\sum }_{j = 1}^{NT - 1} {\sum }_{k = j + 1}^{NT} {h}_{i , j} {h}_{i , k} {x}_{j} {x}_{k} ) ) \\ f ( y \text{\vert} x ) = {\prod }_{i = 1}^{NR} f ( {y}_{i} \text{\vert} x ) \\ = exp [ - \frac{1}{{σ}_{n}^{2}} {\sum }_{i = 1}^{NR} {y}_{i}^{2} ] exp [ - \frac{{a}^{2}}{{σ}_{n}^{2}} {\sum }_{i = 1}^{NR} {\sum }_{j = 1}^{NT} {h}_{i , j}^{2} ] \cdot \\ exp [ - \frac{2 a}{{σ}_{n}^{2}} {\sum }_{i = 1}^{NR} ( {y}_{i} {\sum }_{j = 1}^{NT} {h}_{i , j} {x}_{j} ) ] \\ exp [ \frac{- 2 {a}^{2}}{{σ}_{n}^{2}} {\sum }_{i = 1}^{NR} {\sum }_{j = 1}^{NT - 1} ( {h}_{i , j} {x}_{j} {\sum }_{k = j + 1}^{NT} {h}_{i , k } {x}_{k} ) ] .\end{matrix}$$

The first two terms are common to all elements of the distribution and so can be removed.

Now, defining

$$\begin{matrix}z = \frac{4 a}{{σ}_{n}^{2}} {H}^{T} y and & \begin{matrix}( 2 ) \\ \end{matrix} \\ R = - \frac{4 {a}^{2}}{{σ}_{n}^{2}} {H}^{T} H , & ( 3 )\end{matrix}$$

i.e. a ‘normalised’ matched filter model, the expression becomes:

$$f ( y \text{\vert} x ) ∝ {\prod }_{i = 1}^{NT} exp ( {x}_{i} {z}_{i} ) \cdot {\prod }_{i = 1}^{NT - 1} {\prod }_{j = i + 1}^{NT} exp ( {x}_{i} {x}_{j} {r}_{i , j} ) . \qquad ( 4 )$$

Recalling that the elements of x are either +1 or −1, each element of the joint posterior distribution is therefore just a multiplication of the appropriate terms of several binary distributions corresponding to the prior information, the elements of z and one half (either top or bottom as both are equal) of R. The total number of binary distributions to consider is then

$$2 {N}_{T} + \frac{1}{2} {N }_{T} ( {N}_{T} - 1 ) .$$

Indeed, defining

$$\begin{matrix}{fz}_{i} ( x ) = \frac{exp ( {xz}_{i} )}{exp ( {z}_{i} ) + exp ( - {z}_{i} )} \\ and & ( 5 ) \\ {fr}_{i , j} ( x ) = \frac{exp ( {xr}_{i , j} )}{exp ( {r}_{i , j} ) + exp ( - {r}_{i , j} )} & ( 6 )\end{matrix}$$

obtains the final expression of equation (8), suitable for implementation by analogue circuitry:

$$\begin{matrix}f ( y \text{\vert} x ) ∝ {\prod }_{i = 1}^{NT} {fz}_{i} ( {x}_{i} ) \cdot {\prod }_{i = 1}^{NT - 1} {\prod }_{j = i + 1}^{NT} {fr}_{i , j} ( {x}_{i} {x}_{j} ) & ( 7 ) \\ f ( x \text{\vert} y ) ∝ {\prod }_{i = 1}^{NT} [ {fz}_{i} ( {x}_{i} ) \cdot {f}_{prior}^{i} ( {x}_{i} ) ] \cdot {\prod }_{i = 1}^{NT - 1} {\prod }_{j = i + 1}^{NT} {fr}_{i , j} ( {x}_{i} {x}_{j} ) & ( 8 )\end{matrix}$$

Thus, for example, in the case of an N_{T}=3 MIMO decoder, the joint posterior probability for the three-bit combination [+1,+1,−1] given a received signal y, can be calculated as
p([+1,+1,−1]|y)=exp(+z₁)exp(+z₂)exp(−z₃)exp(+R₁₂)exp(−R₁₃)exp(−R₂₃),
where for N_{T}=3, z=(z₁,z₂,z₃)^{T}, and R₁₂, R₁₃ and R₂₃ are the elements in the top half of the N_{T}×N_{T} matrix R (it will be appreciated that the lower half is equally applicable).

Notably, the probability calculation is comprised solely of multiplications. In addition to being very simple, such a calculation is commutative and so can be conducted in any order.

Table 1 below illustrates one such order for multiplying the relevant elements of z and R to obtain the probabilities for the 8 possible permutations of x for N_{T}=3. For each permutation below, a columnar multiplication is performed to obtain the probability.

TABLE 1
Calculation of the elements of joint posterior distribution for N_{T} = 3.

| | f(x =1, 1, 1\|y) | f(x =1, 1, −1\|y) | f(x =1, −1, 1\|y) | f(x =1, −1, −1\|y) | f(x =−1, 1, 1\|y) | f(x =−1, 1, −1\|y) | f(x =−1, −1, 1\|y) | f(x =−1, −1, −1\|y) |
|---|---|---|---|---|---|---|---|---|
| R23 | + | − | − | + | + | − | − | + |
| R13 | + | − | + | − | − | + | − | + |
| R12 | + | + | − | − | − | − | + | + |
| Z3 | + | − | + | − | + | − | + | − |

| | | | | |
|---|---|---|---|---|
| Z2 | + | − | + | − |

| | | |
|---|---|---|
| Z1 | + | − |

Once all the permutations are calculated, the probabilities can be marginalised to obtain the posterior probabilities for the transmitted bits:

$$f ( {x}_{i} \text{\vert} y ) = {\sum }_{- i}^{} f ( x \text{\vert} y ) . \qquad ( 9 )$$

Whilst the above process applies to binary phase shift keying, the same principle can be applied to higher order modulations, such a quadrature phase shift keying (QPSK).

Thus, in a further example, a QPSK MIMO system is provided with N_{T} transmit antennas and N_{R} receive antennas. The signal model is of this example is described by:
y=a·Hs+n
sᵢ=xᵢ+jx_{i+NT}
i.e. 2N_{T} bits are transmitted over an N_{T}×N_{R} MIMO channel H, where each entry h_{j,i} represents the complex channel between transmit antenna i and receive antenna j.

This situation is equivalent to a 2N_{T}×2N_{R} BPSK case with

$$\begin{matrix}\tilde{H} = [ \begin{matrix}Re ( H ) & - Im ( H ) \\ Im ( H ) & Re ( H )\end{matrix} ] \\ \tilde{y} = [ \begin{matrix}Re ( y ) \\ Im ( y )\end{matrix} ] .\end{matrix}$$

However, given the particular structure of the resulting matrix, the problem can be further simplified. The matched filter matrix in this case is

$$\tilde{R} = {\tilde{H}}^{T} \tilde{H} = [ \begin{matrix}Re ( {H}^{H} H ) & - Im ( {H}^{H} H ) \\ Im ( {H}^{H} H ) & Re ( {H}^{H} H )\end{matrix} ] .$$

The top left and bottom right parts of the resulting matrix are equal. Moreover, the diagonal of the top right matrix is all zeros and both halves are equal with opposite signs.

Taking this into account, equation (4) can be re-written for the QPSK case, resulting in

$$\begin{matrix}\begin{matrix}f ( y \vert x ) ∝ {\prod }_{i = 1}^{NT} [ exp ( {x}_{i} Re ( {z}_{i} ) ) exp ( {x}_{i + NT} Im ( {z}_{i} ) ) ] . \\ {\prod }_{i = 1}^{NT - 1} {\prod }_{j = i + 1}^{NT} [ exp ( {u}_{i , j} Re ( {r}_{i , j} ) ) exp ( {v}_{i , j} Im ( {r}_{i , j} ) ) ] \\ where \\ z = \frac{4 {a}^{2}}{{σ}_{n}^{2}} {H}^{H} y\end{matrix} & ( 10 ) \\ \begin{matrix}R = - \frac{4 {a}^{2}}{{σ}_{n}^{2}} {H}^{H} H \\ {u}_{i , j} = \frac{{x}_{i} {x}_{j} + {x}_{i + NT} {x}_{j + NT}}{2} \\ {v}_{i , j} = \frac{{x}_{i + NT} {x}_{j} - {x}_{i} {x}_{j + NT}}{2}\end{matrix} & ( 11 )\end{matrix}$$

Thus, the situation is the same as in the BPSK case, with just multiplications of the terms of binary distributions.

It will be appreciated that for the QPSK case, u_{i,j} and v_{i,j} can be equal to 1, −1 or 0, and that for all the possible values of x, one and just one of them is different from zero. This means that even though the number of elements of R has been doubled, the number of those that affect each term of the joint posterior distribution remains the same as for the BPSK case. This, together with some elements of R being zero, affects the size of the resulting analogue circuit, contributing to making the number of transistors needed for a QPSK detector with N_{T} transmit antennas proportionally smaller than for a BPSK detector with 2N_{T} antennas.

Analogue Implementation

FIG. 1A illustrates, in accordance with an embodiment of the present invention, circuits constructed using translinear theory which multiply two probability distributions. That is, the circuits obtain all the pair-wise products of the elements (currents) of the input distributions. The general circuit depicted in FIG. 1A receives two sets of currents as inputs, each one representing a discrete probability density function. The resulting output currents correspond to the scaled elements of the product distribution, i.e.

$${Iz}_{i , j} = \frac{{Ix}_{i} {Iy}_{j}}{{\sum }_{k = 1}^{N} {Iy}_{i}}$$

Referring now to FIG. 1B, an alternative embodiment is provided in which the diode-connected transistors shown in FIG. 1A are omitted, and the log-likelihoods of the y distribution are directly input in the form of voltages, i.e.

$$\begin{matrix}{Vy}_{j} = {V}_{T} log ( {p}_{y} ( {y}_{j} ) ) \\ {Iz}_{i , j} = {Ix}_{i} \frac{exp ( \frac{{Vy}_{j}}{{V}_{T}} )}{{\sum }_{k = 1}^{M} exp ( \frac{{Vy}_{k}}{{V}_{T}} )}\end{matrix}$$

where V_{T} is the thermal voltage. This approach allows direct connection of the input values Vzᵢ=V_{T}zᵢ, Vr_{i,j}=V_{T}r_{i,j} to the decoder without converting to currents first, as the structure inherently performs the log-likelihood to probabilities mapping prescribed by equations (5) and (6).

H. A. Loeliger, F. Lustenberger, M. Helfenstein, and F. Tarkoy describe similar circuits in “Probability propagation and decoding in analog VLSI,” IEEE Transactions on Information Theory, September 2000. However, this paper does not discuss these circuits in the context of the present invention, nor does it describe the technical effects delivered by the present invention nor the specific embodiments thereof described herein.

Thus, for example, in an N_{T}=2 MIMO detector the posterior log likelihood ratios of the bits would be given by

$$\begin{matrix}{L}_{1} = {z}_{1} + 2 tan {h}^{- 1} ( tan h ( \frac{{z}_{2}}{2} ) tan h ( \frac{{R}_{12}}{2} ) ) \\ {L}_{2} = {z}_{2} + 2 tan {h}^{- 1} ( tan h ( \frac{{z}_{1}}{2} ) tan h ( \frac{{R}_{12}}{2} ) ) .\end{matrix}$$

For a larger system, referring back to the binary element calculations of Table 1, FIG. 2 shows an array of transistors implementing an equivalent table, producing an analogue decoding tree for an N_{T}=3 MIMO detector in which the output currents of the VR₂₃ layer of transistors provide the probability for each of the eight possible combinations of bits.

Referring now to FIG. 3, the next task is to marginalise out the variables. This may be achieved by obtaining copies of the resulting currents from the output layer of the decoding tree and summing them appropriately, as seen in equation 9. A marginaliser circuit for an N_{T}=2 MIMO is shown in FIG. 3. The output of the marginaliser can be the posterior probabilities but in FIG. 3 diode-connected transistors are used enabling the posterior log-likelihood ratios to be output as indicated.

However, consideration of equations (2) and (3) suggests that the marginalisation circuit of FIG. 3 may perform less well in high signal to noise conditions, as the input voltages to the circuit would be comparatively high. In such circumstances, the circuit will become less accurate when handling distributions where all the probabilities are close to 0 or 1.

This problem may be avoided by limiting the input voltages, for example by suppressing the noise variance dependent upon the nature of the input. If z and R are defined as:
z=aH^{T}y
R=−a²H^{T}H,
then when the signal-to-noise ratio is high, the resulting output joint distribution is a flattened version of the real distribution, because the decoder no longer has information about the noise. In effect, z and R above are equivalent to equations (2) and (3) with σₙ²=2.

In this case, whilst the peak in the distribution would be at the same value as before, errors in the bit decisions can occur during marginalisation because all terms of the posterior distribution are flattened and hence very similar.

Therefore, in an embodiment of the present invention, a solution to avoid such errors comprises a marginaliser constructed to just pick the highest probability (the peak in the distribution), instead of summing them all. In log likelihood notation this would be

$${L}_{i} ( {x}_{i} ) \approx \frac{2}{{σ}_{n}^{2}} log ( \frac{{max}_{xi = 1} ( f ( x \vert y ) )}{{max}_{xi = - 1} ( f ( x \vert y ) )} ) .$$

This approximation does not introduce errors, as low-probabilities are only discarded at the end (when they have already been calculated and identified). Consequently, the same hard decisions are obtained as in an optimal maximum likelihood scheme, even though the actual soft values obtained differ.

Using such a high-probability marginalisation scheme, problems with generating high input voltages, and the accuracy requirements for the decoder, are eased.

In an embodiment of the present invention, an analogue implementation of such a marginaliser requires a circuit that is able to pick the highest of several input currents, together with a multiplier to scale the result according to the noise information.

Several suitable multiplier structures can be found in the literature, e. g. Mohammed Ismail, Terri Fiez “Analogue VLSI. Signal and Information Processing”, McGraw-Hill, Inc., 1994, ISBN 0-07-032386-0.

However, a circuit for picking out the highest current is readily found in the field of artificial neural networks, where a ‘winner takes all’ (WTA) circuit models the competition between neurons in response to a stimulus; e. g. Lazzaro J. P., Ryckebusch S., Mahowald M. A and Mead C. A. “Winner-Take-All Networks of O(N) Complexity”, Advances in neural information processing systems 1 pp 703-711, 1989, ISBN 1-558-60015-9.

FIG. 4 shows a circuit which is based upon work published by C.-Y. Huang and B.-D. Liu., in “Current mode multiple input maximum circuit for fuzzy logic controllers,” (Electron. Lett., vol. 30, no. 23, pp. 1924-1925, 1994). This is derived from the field of artificial neural networks.

The circuit comprises N cells, each of which comprises two transistors, Mi1 and Mi2. The gat of the first transistor Mi1 and the source of the second Mi2 are connected. This node of each cell are in turn connected in common to a single diode-connected transistor My acting as a current source. Further, the drain of the first transistor Mi1 is arranged to receive the current Ii input to represent the respective input probability. The gate of the second transistor Mi2 is connected to the drain of the first transistor Mi1 also. The source of the first transistor Mi1 in each cell is held to ground. The drains of the respective second transistors Mi2 of all cells are connected together and form an output line, operable to output a current iₒᵤₜ indicative of the highest current input, and thus the highest input probability.

The gate-source potential of all Mi1 transistors is the same, which means that they would all sink the same amount of current if their drain-source potentials were all the same. However, the input currents are different for each cell, which renders the drain potential of the winner cell the highest of all, which in turn results in transistor Mi2 of the winner cell taking most of the common line current. The positive feedback eventually turns off the Mi2 transistors of the non winner cells. In that case, Mi1 of the winner cell and My will form a current mirror, so the current through the common line (which in turn is the output current) will be equal to the maximum input current.

Referring now to FIG. 5 and 6, in an embodiment of the present invention, circuits are illustrated which are used to obtain output probabilities for layer Vz₃ of the analogue decoding tree. Referring also to FIGS. 7 and 8, the illustrated circuits are used to obtain output probabilities for layer VR₂₃ of the analogue decoding tree for the eight possible bit combinations in an N_{T}=3 MIMO.

Referring now to FIG. 9, in an embodiment of the present invention, a circuit arrangement, efficiently incorporating the joint posterior distribution calculation functionality of the circuits of FIGS. 5 to 8, as depicted in FIG. 9, obtains output probabilities for the eight possible bit combinations in an N_{T}=3 MIMO.

Referring now also to FIG. 10, in an embodiment of the present invention, a marginaliser is provided as seen in FIG. 10, which is operable to process currents for each of the N_{T}=3 bits. The circuit comprises two four-input maximum current ciurcuits, whose operation is explained above with reference to FIG. 4, and two current mirrors. A current source connected to both of the current mirrors normalises the outputs from the mirrors.

For reasons of simplicity and clarity, only one marginaliser circuit is illustrated in FIG. 10, though three will be required to resolve three bits. The skilled reader will appreciate that the other two marginaliser circuits can be formed as modifications of that illustrated, changing only the specific terms of the joint posterior distribution that are illustrated as inputs on the left side and the right side of the circuit diagram.

As a result, the value of a bit is determined from the probabilities of the possible combinations of the N_{T} bits arranged on either the left or right hand sides of the marginaliser, as the distributions comprising the same respective bit value in one half of the circuit compete together against the distributions comprising the alternative respective bit value in the other half.

It will be appreciated by a person skilled in the art that the circuits depicted in FIGS. 5 to 10 could be altered to reflect other values of N_{T} and other orderings of z and R element multiplication.

Thus, in an embodiment of the present invention, an analogue MIMO decoder implements a decoding tree based upon multiplications of the terms of binary distributions, using a circuit such a that depicted in FIG. 9, before passing the outputs to N_{T} analogue marginalisers in which one or more of the highest probability currents is selected to identify the value of a respective bit, using circuits such as those shown in FIG. 10.

In another embodiment of the present invention, a receiver comprises such an analogue MIMO decoder.

In another embodiment of the present invention, an equaliser of a magnetic media reader comprises such an analogue MIMO decoder.

In an embodiment of the present invention, a method of decoding a MIMO signal comprises determining a set of binary distributions using an analogue circuit, and applying said binary distributions to at least a first marginalisation circuit to determine the distribution with the highest probability.

It will be clear to a person skilled in the art that the analogue MIMO decoder described herein may comprise a discrete entity, for example an ASIC, or plurality of entities, for example separate analogue processing blocks. Similarly it will be clear to a person skilled in the art that the detector may form part of a wireless MIMO receiver, or an equaliser for a reader of a magnetic storage medium. A more general device may be adapted to incorporate the analogue MIMO decoder, such as an entertainment device for games or streaming media, a laptop or PDA, or a hard drive. Alternatively, the detector may be a functionally separable component such as in a plug-in circuit board, or a peripheral such as a PCMCIA card. As such, components of such devices may be adapted to incorporate the analogue processing step of the decoder by means of software or firmware. For example, the digital signal processing (DSP) means of a receiver may be adapted to interface with an analogue MIMO decoder instead of implementing conventional DSP decoding. As such the required adaptation may be implemented in the form of a computer program product comprising processor-implementable instructions stored on a storage medium, such as a floppy disk, hard disk, PROM, RAM or any combination of these or other storage media or signals.

It will be appreciated by a person skilled in the art that embodiments of the analogue MIMO detector disclosed herein confer some or all of the following advantages:
i. A full probability distribution is calculated, enabling accurate bit determination;
ii. By expressing the desired distribution in terms of just sums and products of the elements of simple binary distributions, the number of transistors required is kept to a minimum.
iii. The use of a marginalisation circuit avoids the problems encountered with high input voltages without distorting the probability distribution.

1. An analogue multiple input, multiple output (MIMO) detector, comprising
an analogue calculator arranged in operation to calculate the binary elements of a joint posterior distribution of the probabilities for a transmitted symbol given a received signal.

2. An analogue MIMO detector according to claim 1 wherein the analogue calculator is operable to output currents representing joint posterior distributions, and further comprising a marginaliser arranged in operation to receive said currents and to select the highest of said currents.

3. An analogue MIMO detector circuit according to claim 2 and configured to detect a plurality of transmitted bitstreams, and comprising a corresponding plurality of marginalisers, each marginaliser being operable to process input currents such that distributions comprising the same respective bit value compete as a whole against the distributions comprising the alternative respective bit value.

4. An analogue MIMO detector according to claim 1 wherein the analogue calculator is operable to receive any one of the following inputs;
i. voltage; and
ii. current.

5. A receiver comprising an analogue MIMO detector in accordance with claim 1.

6. A receiver comprising digital signal processing means operably coupled to an analogue MIMO detector in accordance with claim 1.

7. A magnetic media reader comprising an equaliser in turn comprising an analogue MIMO detector in accordance with claim 1.

8. A method of MIMO signal reception comprising the step of using an analogue circuit to calculate the binary elements of a joint posterior distribution of the probabilities for a transmitted signal given a received signal.

9. A method of MIMO signal reception according to claim 8 further comprising the step of applying said binary distributions to at least a first marginalisation circuit operable to select the binary distribution with the highest probability.

10. A data carrier comprising computer readable instructions that, when loaded into a computer, cause the computer to operate as a receiver operable to couple to an analogue MIMO detector in accordance with claim 1.
